(19) United States
(12) Patent Application Publication
(10) Pub. No.: US 2005/0175530 A1
(43) Pub. Date: Aug. 11, 2005

(54) Process for the preparation of nano-and micro-particles of group II and transition metals oxides and hydroxides, the nano-and micro-particles thus obtained and their use in the ceramic, textile and paper industries

(76) Inventors: Piero Baglioni, Fiesole (IT); Luigi Dei, Firenze (IT); Laura Fratoni, Prato (IT); Pierandrea Lo Nosotro, Firenze (IT); Michelangelo Moroni, Montevarchi (IT)

Correspondence Address: Eitan Pearl;Latzer & Cohen Zedek, Suite 1001, 10 Rockefeller Plaza, New York, NY, 10020, US

(21) Appl. No.: 10/509,107

(22) PCT Filed: Mar. 26, 2003
(86) PCT No.: PCT/IB03/01177

(30) Foreign Application Priority Data
Mar. 28, 2002 (IT) FI2002A000052

(51) Int. Cl. C01G 25/02

(52) U.S. Cl. 423/622; 423/608

(57) ABSTRACT

A process for the preparation of particles of group II and transition metals oxides and hydroxides is described, which provides a homogeneous phase synthesis step by a double exchange reaction and, in the case of oxides, the subsequent calcination of the corresponding hydroxides; the particles thus obtained and their use for surface coatings of ceramic, textile and paper materials are also described.

### FIELD OF THE INVENTION

The invention relates to the field of nano- and micro-particles of oxides and hydroxides of group II metals and transition metals, and their use in the ceramic, textile and paper industries.

### STATE OF THE ART

The international scientific literature pertinent to the synthesis and characterisation of metal oxides and hydroxides having dimensions of less than a micrometer down to the order of a few tens of nanometers is notable and offers an extremely wide range of possibilities for the production of said materials. Unfortunately, almost always, the perfection of these syntheses on the semi-industrial or even industrial scale is extremely complex essentially for two types of reasons: (i) the excessive economical costs, (ii) the poor yield of these synthetic methods. On the other hand in very many fields of application—the ceramic, textile, paper industries, etc.—it would be absolutely advantageous to be able to have these oxides, so finely subdivided, at ones disposal on a large scale so as to be able to obtain surface coatings having high covering power, high adhesion to the support, optimal homogeneity. These surface coatings would be potentially able to confer better interphase properties onto the support material with respect to those of the “naked’ supports, conferring therefore absolutely innovative working performance onto the finished product.

It is therefore necessary to overcome the obstacle represented by the difficulty of preparation of these materials providing a process for the production of nano- and micro-particles of oxides and hydroxides of transition metals and of group II metals, having high yields, modest costs and the actual possibility of expansion onto an industrial or semi-industrial scale.

### DETAILED DESCRIPTION OF THE INVENTION

The present invention allows to overcome the above mentioned problems thanks to a process for the preparation of micro- and nano-particles of oxides and hydroxides of group II and transition metals starting from low cost raw materials, with modest energy costs, high yields and high degree of purity of the final material, and use of reaction solvents with low environmental impact.

The syntheses proceed in a homogeneous phase, at temperatures ranging between 50° C. and 180° C., by dual exchange reaction between an appropriate metal compound solubilised in an aqueous medium or in an organic medium miscible in water, and an alkaline hydroxide in aqueous phase. The metal hydroxide formed through this double exchange reaction is separated from the solution by filtration, by decanting or by centrifugation. Subsequently, the hydroxide is calcinated in air at an appropriate temperature depending on the type of metal. Synthesis by the double exchange reaction at high temperature succeeds in producing very fine particles of metal hydroxide since under these conditions the nucleation speed of the new insoluble phase (the hydroxide) is enormously greater than the speed of growth of the nuclei therefore originating very numerous and very minute crystals of hydroxide which do not have the time nor the method to grow dimensionally. The subsequent calcination of the hydroxide to oxide does not alter the dimensions of the particles, instead it tends to produce a further decrease in the particles dimensions.

Operating with this type of synthetic strategy one attains the following scopes:
a) none of the particles synthesised has dimensions greater than a micrometer;
b) the yield is exceptionally high because it practically coincides with the stoichiometry of the reaction, because the equilibria of reaction are completely moved to the right;
c) sometimes the particles agglomerate with each other to form super-micrometric aggregates even allowing filtration or separation by simply decanting (however, when such a situation does not occur, the product in dispersion can be recovered by centrifugation);
d) the super-micrometric aggregates, when they form, are easily refragmented into the nanometric units by the subsequent calcination process;
e) the final product of the calcination—the oxide—once cooled, is easily dispersed in an appropriate liquid medium for the application onto solid surfaces by the spraying technique. The invention hence relates to methods for the production of particles of oxides and hydroxides of group II metals and transition metals as herein after further specified; it relates also to said particles and their use in processes for the surface coating of ceramic, textile and paper materials.

In addition, the invention relates to dispersions of said particles in appropriate liquid dispersing media for applicative use in the form of aerosols for the deposition of the particulate onto ceramic, textile and paper surfaces.

According to the invention, by “nano- micro-metric particles” particles having dimensions comprised of between 10 and 1000 nm are meant, preferably 50-500 nm.

Preferred according to the invention are the oxides and hydroxides of zinc, titanium, zirconium, aluminium, cobalt, iron, nickel, magnesium.

Particularly preferred are the oxides and hydroxides of zinc, titanium, aluminium, zirconium.

By the term “metal compound” according to the invention, a salt of the metals, which is soluble in water, is meant.

Amongst said salts, particularly preferred are chlorides, nitrates and acetates.

In particular according to the invention, the following salts are preferred: ZrCl₄, ZrOCl₂, TiCl₄, TiF₄, TiOCl₂, Mg(NO₃)₂, Co(NO₃)₃, ZnCl₂, Ni(NO₃)₂, FeCl₃.

The liquid medium into which the metal compound is dissolved to make the synthetic process take place, can be water, a diol, dimethyl sulphoxide, or 1,2,3-propanetriol.

If a diol is used, this is preferably selected from the group consisting of 1,2-ethanediol and 1,2-propanediol.

The alkaline solution used to react with the above solution of the metal compound, can be constituted, for example, by an aqueous solution of NaOH, KOH, Ba(OH)₂. The concentration of the reagents (metal compound solution and alkaline solution) are not essential and depend from case to case, as the ratio between the reagents does, which can be stoichiometric or not (see the examples).

The double exchange reaction can take place at any temperature ranging between 50° C. and 180° C.

The hydroxides thus synthesised can be purified, by washing and ultrasonic treatment, from any inorganic type of impurities not decomposable at the calcination temperatures. The purification of the hydroxides from organic materials is carried out through repeated washes with 1-propanol.

The calcination of the hydroxides takes place in air (or in an inert atmosphere if the hydroxide was washed and purified from any trace of organic materials) at temperatures ranging between 250° and 1100° C.

The hydroxides, or the oxides obtained from the calcination process, can be dispersed in appropriate liquid media with the help of ultrasound or metallic paddle mechanical homogenisers.

The liquid media for the above dispersions are preferably constituted by water, ethanol, propanol, isopropanol.

The method for the attainment of these particles is illustrated in the following examples; the examples also contain the method of dispersion of the oxide or hydroxide particles, and also the procedure for the spraying of the dispersions onto ceramic, paper and textile supports.

The particles of the oxides or hydroxides have been characterised by scanning electron microscopy with X-ray scattering spectrometry, transmission electron microscopy, differential thermal analyses and X-ray diffractometry. The dispersion of the oxides or hydroxides in liquid medium have been characterised by light diffusion to determine the granulometric distribution, and by measurement of the zeta potential for the evaluation of surface charge. The ceramic and paper surfaces coated with the layers of oxides produced with the present invention have been characterised by scanning electron microscopy with X ray dispersion spectrometry. The textile surfaces coated with the layers of oxides produced with the present invention have been characterised, furthermore, with the methods used for the ceramic and paper materials, also by UV/visible absorbance/reflection/diffusion spectrometry, to evaluate the effective screening with respect to electromagnetic radiations of the textile surfaces coated with the oxide products of the present invention.

### EXAMPLE 1

Into 200 ml of ethylene glycol are dissolved 13.2 g of ZrOCl₂.8H₂O. The solution (0.2 M) is gradually heated, keeping it under constant stirring and at a temperature of approx. 150° C. 14 ml of 5 M NaOH are added dropwise until the complete precipitation of the zirconium hydroxide. After having cooled to room temperature, the gelatinous precipitate is left to decant. The overlying solution is aspirated with a pipette, the precipitate is instead diluted 1:10 with MILLI-Q water and sonicated in an ultrasonic bath for approx. 15 minutes. It is centrifuged in 25 ml plastic tubes for around 15 minutes at a speed of 5000 rpm, so as to separate the supernatant from the gelatinous phase. The same procedure is repeated three times, until the concentration of NaCl becomes around 10⁻⁵ M (assay with AgNO₃). Thus the hydroxide is obtained.

The hydroxide is calcinated, in a muffler furnace, at 550° C. for around 3 hours and the final product is thus obtained, i.e. zirconium oxide with particle dimensions ranging from 80 to 300 nm.

With the thus synthesised nanometric zirconium powders is prepared a 10⁻² M aqueous dispersion. Such a dispersion is sprayed onto a sample of ceramic stoneware cooked at 1150° C., the sample is then re-cooked for 30 minutes at 1000° C. to form a homogeneous surface coating which confers improved structural properties over the ceramic material.

### EXAMPLE 2

Into 200 ml of MILLI-Q water are dissolved 13.2 g of ZrOCl₂.8H₂O. The solution (0.2 M) is gradually heated, keeping it under constant stirring and at a temperature of around 95° C. 14 ml of 5 M NaOH is added dropwise until the complete precipitation of the zirconium hydroxide. After having cooled to room temperature, the gelatinous precipitate is left to decant. The supernatant solution is aspirated with a pipette, the precipitate is instead diluted 1:10 with MILLI-Q water and sonicated in an ultrasonic bath for around 15 minutes. It is centrifuged in 25 ml plastic tubes for around 15 minutes at a speed of 5000 rpm, so as to separate the supernatant from the gelatinous phase. The same procedure is repeated three times, until the concentration of NaCl becomes around 10⁻⁵ M (assay with AgNO₃). The hydroxide is thus obtained.

The hydroxide is calcinated, in a muffler furnace, at 550° C. for around 3 hours and thus the zirconium hydroxide is obtained with the dimensions of the particles ranging from 80 to 300 nm.

With the nanometric zirconium powders thus synthesised is prepared a 10⁻² M aqueous dispersion. Such a dispersion is sprayed onto sample of ceramic stoneware cooked at 1150° C., the sample is then re-cooked for 30 minutes at 1000° C. to form a homogeneous surface coating which confers improved structural properties over the ceramic material.

### EXAMPLE 3

As for examples 1 and 2 but the application is made by brush instead of by spray. The remaining procedures are totally identical.

### EXAMPLE 4

As for examples 1 and 2 but the application is made by spraying or brushing the appropriately purified hydroxide instead of the oxide.

### EXAMPLE 5

Into 200 ml of ethylene glycol are dissolved 5.45 g of ZnCl₂. The solution (0.2 M) is gradually heated, keeping it under constant stirring at a temperature of around 150° C. 14 ml of 5 M NaOH is added dropwise until the complete precipitation of the zinc hydroxide. After having cooled to room temperature, the gelatinous precipitate is left to decant. The supernatant solution is aspirated by a pipette, the precipitate is instead diluted 1:10 with MILLI-Q water and sonicated in an ultrasonic bath for around 15 minutes. It is centrifuged in 25 ml plastic tubes for around 15 minutes at a speed of 5000 rpm, so as to separate the supernatant from the gelatinous phase. The same procedure is repeated three times, until the concentration of NaCl becomes around 10⁻⁵ M (assay by AgNO₃). The hydroxide is thus obtained.

The hydroxide is calcinated, in a muffler furnace, at 250° C. for around 3 hours and the zinc oxide is thus obtained with dimensions of particles from 50 to 500 nm.

With the nanometric zinc oxide powder thus synthesised is prepared a 10⁻² M aqueous dispersion. A fragment of wool fabric is immersed in said dispersion and left in it with stirring for 20 hours: Later, the fabric is washed many times in pure water, dried and onto the surfaces of the fabric are performed characterisations using a scanning electron microscope fitted with an EDX microprobe from which is revealed the presence of a ZnO articulate strongly bound to the wool fibre. The UV/VIS reflectance investigation shows that the fabric thus treated has opaque properties towards ultraviolet light dangerous to health much greater than the non treated fabric.

1. A process for the preparation of oxides and hydroxides of group II metals and transition metals in the form of nano- micro-particles comprising the following steps:
a) double exchange reaction, in aqueous or organic phase, between a metal compound and an alkaline hydroxide
b) calcination of the metal hydroxide obtained in step a).

2. The process according to claim 1, wherein the group II and transition metal oxides or hydroxides are selected from the group consisting of oxides or hydroxides of: zinc, zirconium, titanium, magnesium, iron, cobalt, nickel.

3. The process according to claim 1, wherein the metal compound is a salt soluble in water.

4. The process according to claim 3, wherein the salt is a: chloride, nitrate, acetate.

5. The process according to claim 3, wherein the salts are: ZrCl₄, ZrOCl₂, TiCl₄, TiF₄, TiOCl₂, Mg(NO₃)₂, Co(NO₃)₃, ZnCl₂, Ni(NO₃)₂, FeCl₃.

6. The process according to claim 1, wherein:
a) a solution of a group II or transition metal chloride and an aqueous solution of an alkaline hydroxide are made to react in homogeneous phase;
b) the metal hydroxide formed in the previous step is collected by centrifugation, filtration or decanting and optionally purified by washing or treatment with ultrasound;
c) the hydroxide is calcinated in air or in inert atmosphere.

7. The process according to claim 6, wherein the chloride of the transition metal is dissolved in water or in an organic solvent miscible with water.

8. The process according to claim 7, wherein the organic solvent is selected from the group consisting of diols, 1,2,3-propanetriol and dimethyl sulphoxide.

9. The process according to claim 8, wherein the diol is selected from the group consisting of 1,2-ethanediol and 1,2-propanediol.

10. The process according to claim 6, wherein the reaction in step a) is carried out at a temperature ranging between 50° and 180° C.

11. The process according to claim 6, wherein the calcination takes place at a temperature ranging between 250° and 1100° C.

12. Oxides and hydroxides of group II and transition metals in the form of particles having dimensions ranging between 10 and 1000 nm obtained according to the process defined in claim 1.

13. Oxides and hydroxides according to claims 12, wherein the particles have dimensions ranging between 50 and 500 nm.

14. Dispersions containing the oxides or hydroxides as defined in claim 12.

15. Dispersions according to claim 14, wherein the liquid of the dispersion is selected from the group consisting of water, ethanol, propanol and isopropanol.

16. Process for the treatment of ceramic surfaces, textile products, or paper materials wherein oxides and hydroxides as defined in claim 12 are used.

17. Dispersions containing the oxides or hydroxides as defined in claim 13.

18. Process for the treatment of ceramic surfaces, textile products, paper materials wherein oxides and hydroxydes as defined in claim 13 are used.

19. Process for the treatment of ceramic surfaces, textile products, paper materials wherein the dispersions as defined in claim 14 are used.

20. Process for the treatment of ceramic surfaces, textile products, paper materials wherein the dispersions as defined in claim 17 are used.
